(19) United States
(12) Patent Application Publication
(10) Pub. No.: US 2003/0002194 A1
(43) Pub. Date: Jan. 2, 2003

(54) Record and playback apparatus, and the method

(75) Inventor: Tsuyoshi Andoh, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/080,411

(22) Filed: Feb. 25, 2002

(30) Foreign Application Priority Data
May 17, 2001 (JP) 2001-148058

(51) Int. Cl. G11B 19/02

(52) U.S. Cl. 360/69

(57) ABSTRACT

In a record and playback apparatus which codes information and records the information which is coded in a recording medium, the record and playback apparatus stores, in a predetermined management area provided in the recording medium, management information including at least one of time information (14b) on a time when the information is coded, index information (14c) which can be assigned to a recording unit, and a backward pointer (14d) for connecting recording units in a backward direction.

### BACKGROUND OF THE INVENTION

1. Field of the Invention

The present invention relates to a record and playback apparatus. More particularly, the present invention relates to controlling a file system which manages recording of information in a record and playback apparatus which encodes information such as an image or voice by MPEG-2 and the like and records the encoded information in a recording medium.

2. Description of the Related Art

Recently, a record and playback apparatus which encodes analog broadcast to digital data by using MPEG-2, records the digital data in a recording medium such as a hard disk which allows random access and plays back the analog broadcast is being developed. A recording medium allowing random access represented by the hard disk can be searched at higher speed than a tape medium of sequential access. Thus, high speed playback in response to a user action is available according to the recording medium which allows random access.

Recording of information is performed by using a file format, and, record and playback of information is managed by a file system.

FIG. 1 shows a conventional file system. A DIR (directory) area 10, a FAT (File Allocation Table) area 11, and a DISK area 12 are provided on a recording medium. The DIR area 10 and the FAT area 11 are used for file management information. The file system performs various file management such as recording and playback of a file by using this file management information.

The DIR area 10 includes DIR entry tags (each having n bytes), the number of the DIR entry tags corresponds to the number of files. Each DIR entry tag has a file name, date and time of creation, a file size, a leading FAT pointer and the like. The FAT area 11 includes FAT entry tags (each having m bytes). A file is configured by clusters (recording units) stored in the DISK area 12. Each cluster is connected with another cluster by the FAT entry tag. The size of the FAT area 11 can be obtained in the following way.

FAT area size=(hard disk capacity/l cluster size)×1 FAT entry size,

For example, if hard disk capacity is 27 Gbytes, 1 cluster size is 1 Mbytes and 1 FAT entry size is 2 bytes (m=2), the FAT area size is 52 kbytes.

As shown in FIG. 2, a pointer to the leading FAT entry tag described in the DIR entry tag becomes the starting point, and a pointer of a cluster which is used next is stored in the FAT area 11 for each cluster. Each of “1”, “2”, “3” of the FAT entry tags is a value of a pointer 14a. The DIR entry tag indicates a pointer value “1”. A pointer of the leading FAT entry which has this pointer value includes a pointer value “2”. A pointer of a FAT entry tag corresponding to a last cluster becomes a terminal code (null for example). Therefore, coded MPEG-2 data can be accessed from the pointer to the leading FAT entry tag like daisy chain.

Generally, recorded data is encoded by using variable-length coding. When the data is coded by a fixed bit rate, it is possible to search for any FAT entry by using a simple calculation from the bit rate. On the other hand, information size is not fixed when the data is recorded by a variable bit rate. Thus, when locating the start of a recorded sequence by time searching, it is difficult to specify an accurate time. That is, information size does not correspond to the decoded playback image. Therefore, when the data is recorded by variable bit rate, there is a problem in that accurate time search by user instruction can not be performed. Accordingly, there is a problem in that a playback method convenient for a user other than a normal playback method is not provided conventionally.

### SUMMARY OF THE INVENTION

An object of the present invention is to provide a record and playback apparatus and the method which is provided with an easy-to-use playback system.

The above object can be achieved by a record and playback apparatus which codes information and records the information which is coded in a recording medium, wherein:

the record and playback apparatus stores, in a predetermined management area provided in the recording medium, management information including at least one of time information on a time when the information is coded, index information which can be assigned to a recording unit, and a backward pointer for connecting recording units in a backward direction.

According to the present invention, since at least one of time information on a time when the information is coded, index information which can be assigned to a recording unit (corresponding to a cluster for example), and a backward pointer for connecting recording units in a backward direction is recorded in the predetermined management area, an usable play back method can be realized by using the stored information. For example, since the time when the data is coded into the recording unit, that is, time of recording is recorded, accurate time search can be performed even when data is recorded at variable bit rate.

### BRIEF DESCRIPTION OF THE DRAWINGS

Other objects, features and advantages of the present invention will become more apparent from the following detailed description when read in conjunction with the accompanying drawings, in which:

FIG. 1 shows a conventional file system;

FIG. 2 shows a state in which FAT entries are connected by pointers in the file system shown in FIG. 1;

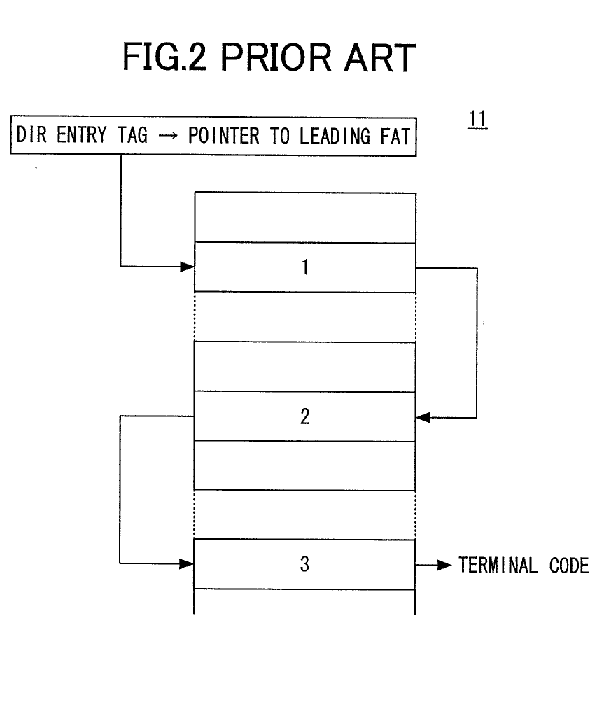

FIG. 3 shows a file system of a first embodiment of the present invention;

FIG. 4 shows a state in which FAT entries are connected by pointers in the file system shown in FIG. 3;

FIG. 5 shows a file system of a second embodiment of the present invention;

FIG. 6 shows a state in which FAT entries are connected by pointers in the file system shown in FIG. 5;

FIG. 7 shows a file system of a third embodiment of the present invention;

FIG. 8 shows a state in which FAT entries are connected by pointers in the file system shown in FIG. 7;

FIG. 9 shows a file system of a fourth embodiment of the present invention;

FIG. 10 shows a state in which FAT entries are connected by pointers in the file system shown in FIG. 9;

FIG. 11 shows a block diagram of a record and playback apparatus of an example of the present invention

FIG. 12 is a block diagram showing the detailed configuration of FIG. 11;

FIG. 13 is a flowchart showing a main flow of recording operation in the record and playback apparatus shown in FIG. 11;

FIG. 14 is a flowchart showing a main flow for playback operation in the record and playback apparatus shown in FIG. 11;

FIG. 15 is a flowchart showing a generation process of a new file in the record and playback apparatus shown in FIG. 11;

FIG. 16 is a flowchart showing existing file open process in the record and playback apparatus shown in FIG. 11;

FIG. 17 is a flowchart showing an existing file close process in the record and playback apparatus shown in FIG. 11;

FIG. 18 is a flowchart showing a DMA process in the record and playback apparatus shown in FIG. 11;

FIG. 19 is a flowchart showing a file access process processed by delay interrupt in the record and playback apparatus shown in FIG. 11;

FIG. 20 is a flowchart showing a file write process in the record and playback apparatus shown in FIG. 11;

FIG. 21 shows a flowchart showing a write process to the FAT area 34 in the record and playback apparatus shown in FIG. 11;

FIG. 22 shows a flowchart indicating a file read process in the record and playback apparatus shown in FIG. 11;

FIG. 23 is a flowchart indicating a FAT read process in the record and playback apparatus shown in FIG. 11;

FIG. 24 is a flowchart showing judgment process of index search instruction in the record and playback apparatus shown in FIG. 11;

FIG. 25 is a flowchart showing judgment process of time search instruction in the record and playback apparatus shown in FIG. 11.

### DETAILED DESCRIPTION OF THE PREFERRED EMBODIMENTS

In the following, embodiments and examples of the present invention will be described.

(First Embodiment)

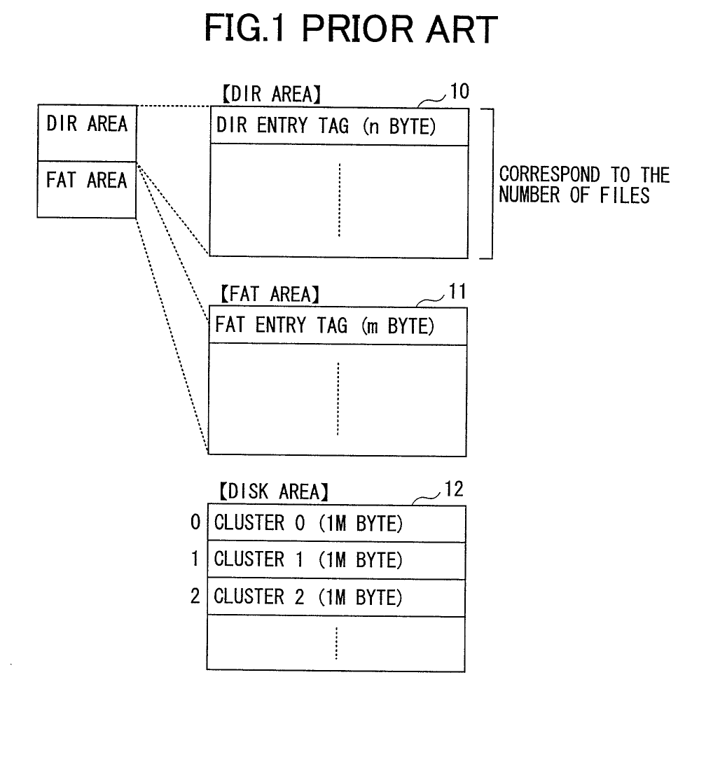

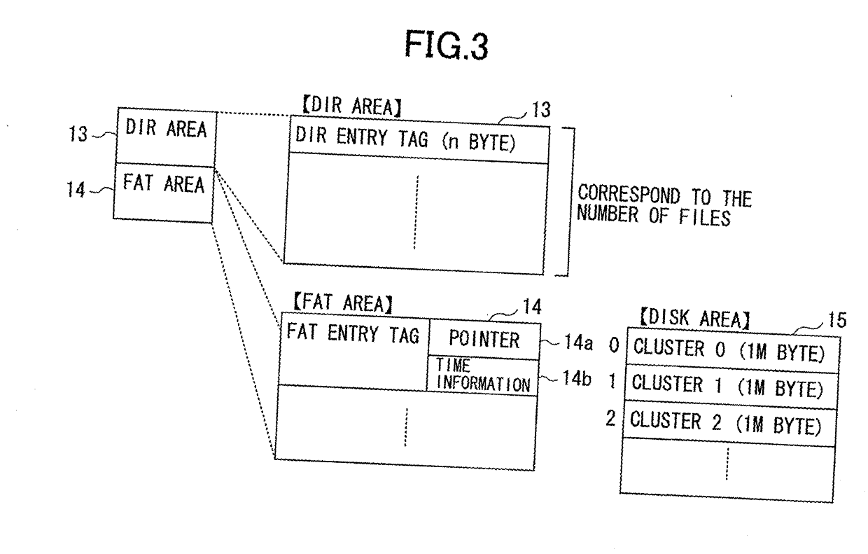

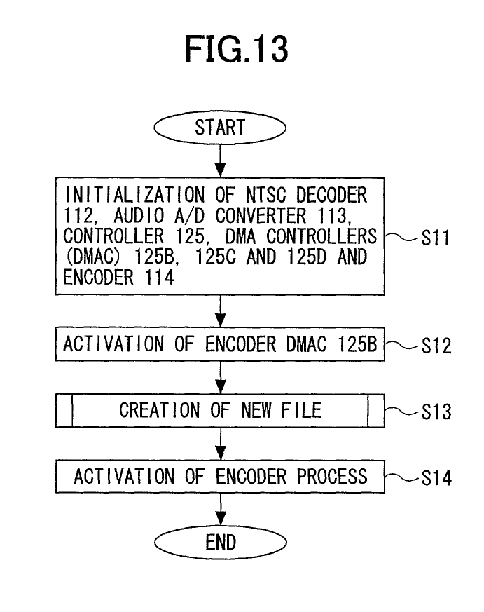

FIG. 3 shows a file system of the first embodiment of the present invention. As shown in FIG. 13, a DIR (directory) area 13, a FAT (File Allocation Table) area 14 and a DISK area 15 are provided on a recording medium. The DIR area 13 and the FAT area 14 are used for file management information. The file system performs various file management by using this file management information. The configuration of the FAT area 14 is different from that of the conventional FAT area 11 shown in FIG. 1. The DIR area 13 and the DISK area 15 are the same as the DIR area 10 and the DISK area 12 shown in FIG. 1 respectively.

Each entry tag in the FAT area 14 includes time information 14b in addition to the FAT entry tag 14a. The time information of the FAT entry tag is management information indicating time when coded data is recorded to a corresponding cluster. The unit of time is second for example. The time information 14b can be obtained by using a clock in the record and playback apparatus.

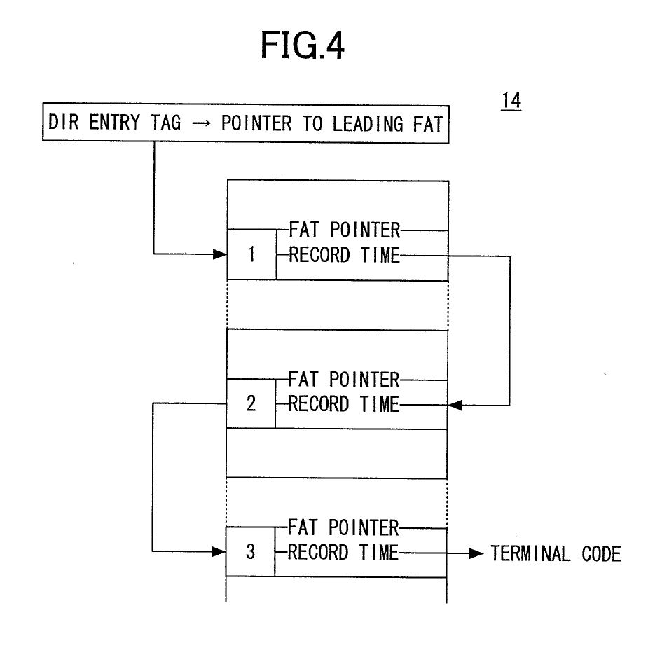

As shown in FIG. 4, a pointer to a leading FAT entry tag which is described in the DIR entry tag becomes a starting point. Each FAT entry tag stores a pointer 14a of a cluster which is used next with the time information 14b of the corresponding cluster. FIG. 4 shows the time information 14b as Record Time.

Each FAT entry tag includes, for example, 2 bytes as the pointer and 2 bytes of the time information, which are 4 bytes in total. When the time information 14b is 2 bytes and the unit of time is 1 second, up to 65535 second (about 18 hours) can be represented by the time information, which is enough length for recording one program. The size of the FAT area 14 can be obtained by the before-mentioned equation. For example, when hard disk capacity is 27 Gbytes, 1 cluster size is 1 Mbytes and 1 FAT entry size is 4 bytes, the FAT area size becomes 104 kbytes.

As mentioned above, according to the first embodiment of the present invention, the pointer 14a and the time information 14b are recorded simultaneously in a FAT entry tag corresponding to each cluster. When a user instructs time search, the FAT entries are traced according to pointers of the FAT entry tags from a pointer to the leading FAT entry tag described in the DIR entry tag as the starting point. At this time, each time information 14b is compared with a time which is specified by the user as the instruction of time search one after another. In this way, a cluster (FAT entry) in which the time information 14b completely agrees with the specified time or the difference between the time information 14b and the specified time is within a predetermined range is searched for. In the following, the case where the time information 14b completely agrees with the specified time or the difference between the time information 14b and the specified time is within a predetermined range is defined as “the times are the same”. Then, playback is started from a cluster specified by the search. Therefore, even when data is recorded by variable bit rate, accurate time search by user instruction can be performed.

Since the time information 14b is recorded for each corresponding cluster, it is possible to realize a function for playing back a recorded program at regular intervals by specifying an time interval, in which the specified time interval is compared with the time information 14b of the FAT entry tag so that clusters having time information corresponding to the specified time interval are specified, and, then, a predetermined amount of data is played back from the cluster. The data amount is determined properly according to the bit rate. For example, when realizing a function of fast-forward, a data amount which corresponds to 1-2 frame is calculated from the bit rate so that the data amount is used for playback. Accordingly, by adjusting the specified time interval, specified times—speed playback and slow playback can be realized.

(Second Embodiment)

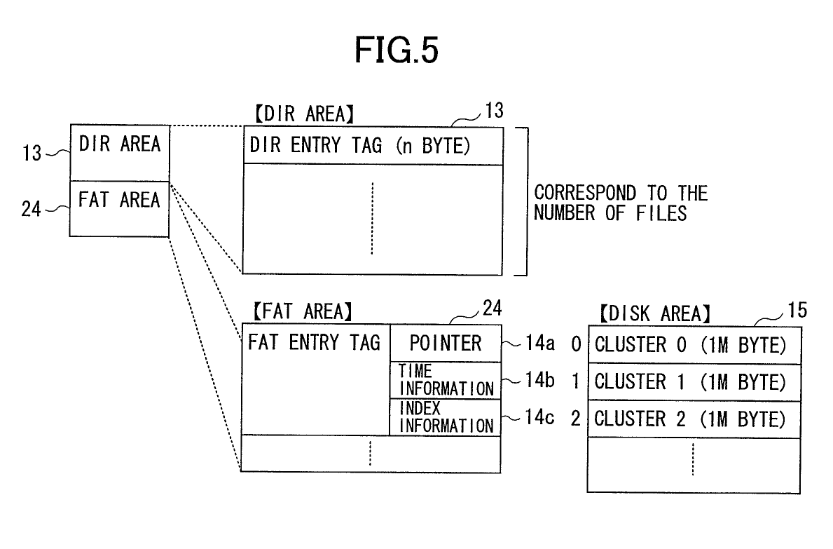

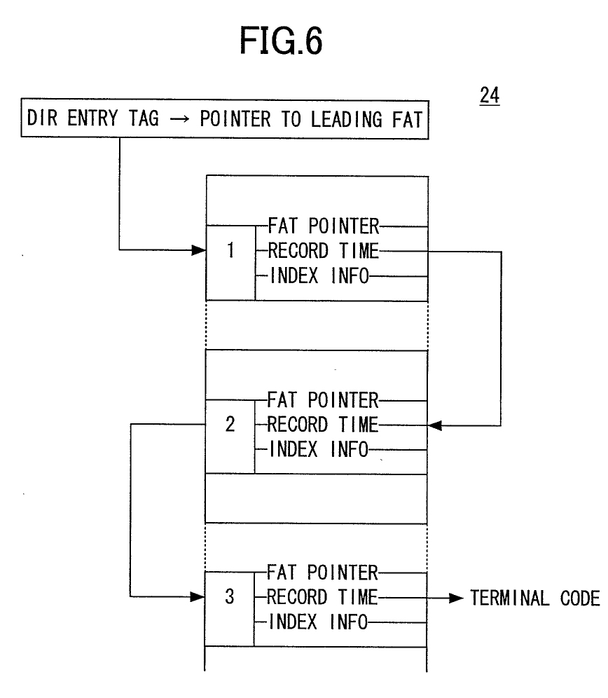

FIGS. 5 and 6 show a file system of the second embodiment of the present invention. In these figures, components same as those shown in FIG. 4 have the same reference numbers as those shown in FIG. 4.

In the second embodiment, a FAT area 24 is provided in which index information 14c is added to each FAT entry tag of the FAT area 14 of the first embodiment. That is, each FAT entry tag stored in the FAT area 24 includes the pointer 14a, the time information 14b and the index information 14c. The index information 14c enables efficient search (search for the start of a recorded program) according to contents such as image and voice recorded in the disk. The index information 14c is, for example, a serial number from 1.

For example, in a music program in which a plurality of artists perform, when recording the program, a user instructs the record and playback apparatus to input index information every time when an artist appears. The index information also may be input when playing back the program. For example, every time when the user instruct to input the index information, the index information 14c is incremented from 1. The index information 14c is recorded in a FAT entry tag of a corresponding cluster. Index information of other FAT entry tags remains blank.

As an example, each FAT entry tag includes 2 bytes as the pointer 14a, 2 bytes as the time information 14b and 2 bytes of index information 14c, which are 6 bytes in total.

(Third Embodiment)

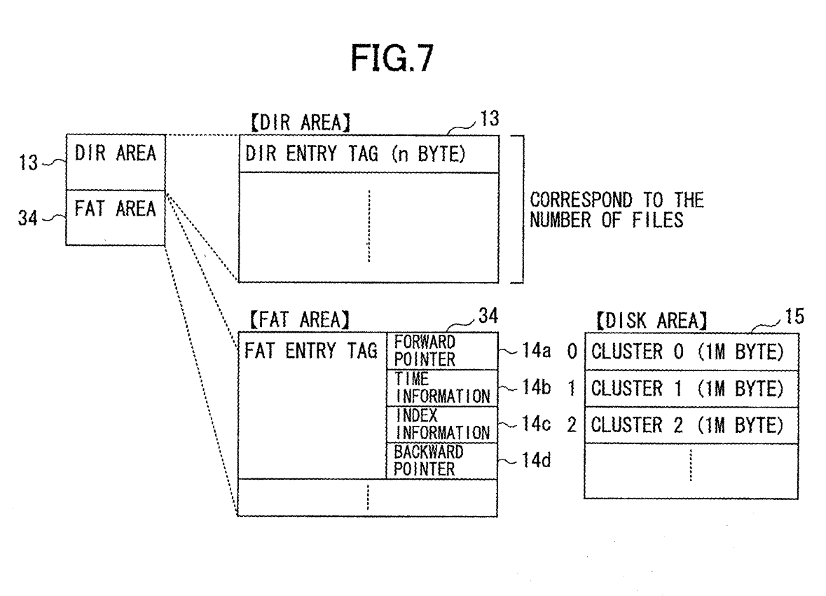

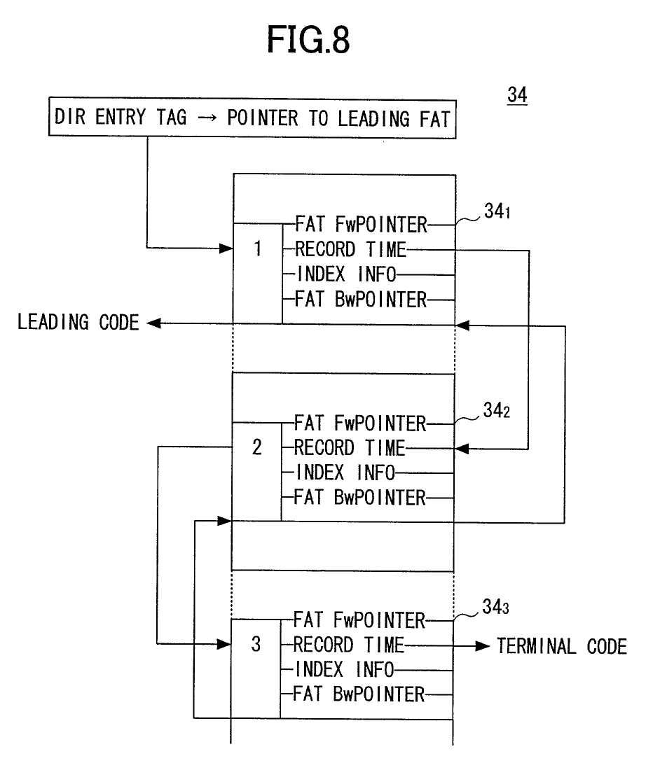

FIG. 7 and FIG. 8 shows a file system according to the third embodiment of the present invention. In these figures, components same as those shown in FIG. 5 have the same reference numbers as those shown in FIG. 5.

In the third embodiment, a FAT area 34 is provided in which a backward pointer 14d is added to each FAT entry tag of the FAT area 24 of the second embodiment. That is, each FAT entry tag stored in the FAT area 34 includes the pointer 14a, the time information 14b and the index information 14c and the backward pointer 14d as management information. In the following, the pointer 14a will be called a forward pointer.

The backward pointer 14d, when recording data, is written into each FAT entry tag corresponding to each cluster. For example, when the FAT entry tags are chained as shown in FIG. 8, the forward pointer 14a of a FAT entry tag of a leading FAT entry 34₁ of “1” indicated by the DIR entry tag has “2” as a pointer value indicating a next FAT entry 34₂. In addition, the forward pointer 14a of a FAT entry tag of the FAT entry indicated by the pointer value “2” has “3” as a pointer value indicating a next FAT entry 34₃. In this case, a backward pointer 14d of the FAT entry 34₃ indicates the pointer value “2” (=“3”−1) indicating a previous FAT entry 34₂. In the same way, the backward pointer 14d of the FAT entry 34₂ indicates the pointer value “1” (=“2”−1) indicating a previous FAT entry. However, since the FAT entry 34₁ is the leading FAT entry, a predetermined leading code is described instead of the pointer value “1”. Accordingly, in the example shown in FIG. 8, a backward pointer 14d described in an FAT entry tag of a nth FAT entry indicates a value of a forward pointer 14a of a (n−1)th FAT entry.

When, a user requests backward playback for a file (program) which has been recorded, it is possible to read out the file according to the order of the backward pointers 14d “3”→“2”→“1” in the example of FIG. 8. For example, there may be a case that backward playback becomes necessary from a time point when playing back the program in the forward direction. For example, when backward playback is requested while a cluster corresponding to a FAT entry 34₂ indicated by a forward pointer “2” is being played back, clusters can be easily traced in the backward direction by referring to the backward pointer 14d of the FAT entry 34₂.

The FAT entry tag includes the time information 14b used in the first embodiment and the index information 14c used in the second embodiment. Therefore, by referring to the backward pointer 14d on backward playback, playback by specifying time or time interval described in the first embodiment, and, locating a start in a program described in the second embodiment become possible.

(Fourth Embodiment)

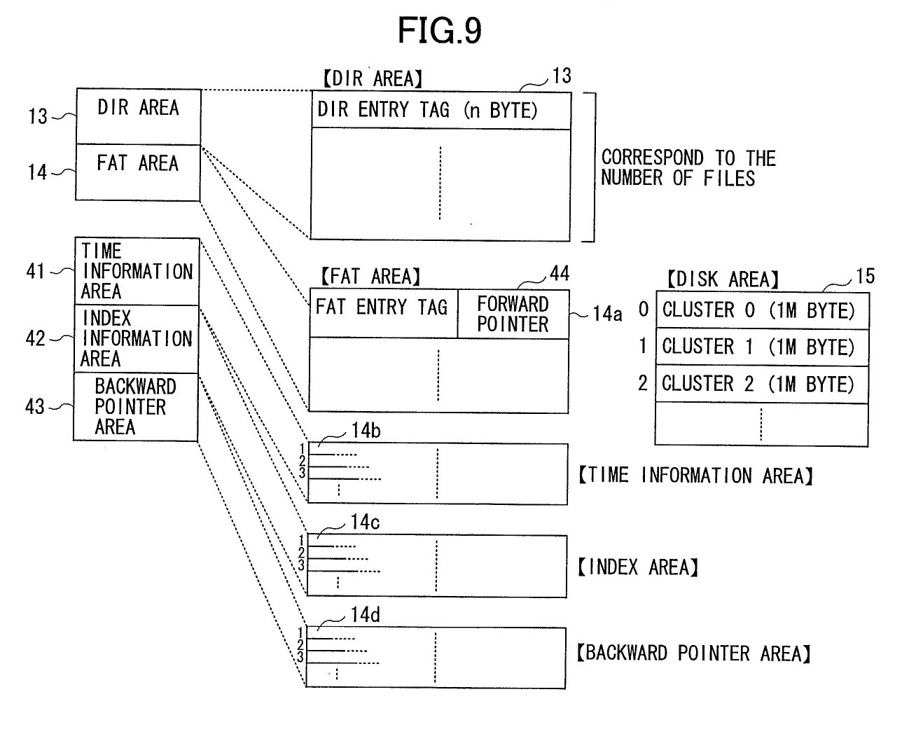

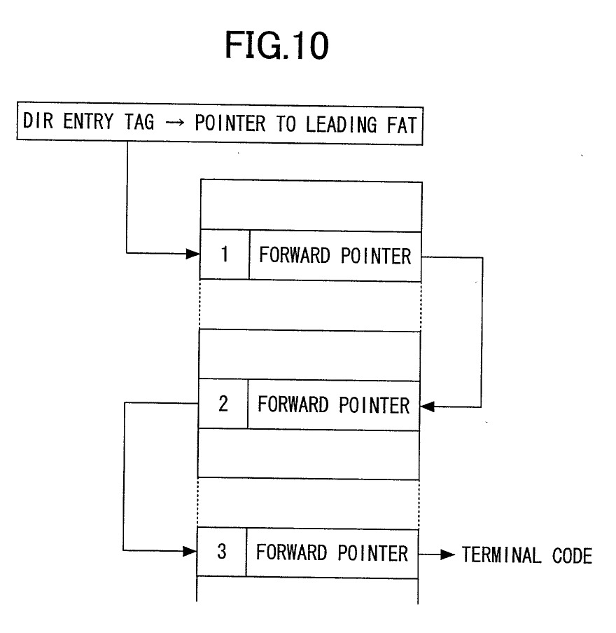

FIG. 9 and FIG. 10 shows a file system of the fourth embodiment of the present invention. In these figures, components same as those shown in FIGS. 8 and 9 have the same reference numbers as those shown in FIGS. 8 and 9. The fourth embodiment is a modification of the third embodiment.

In the third embodiment, each FAT entry tag has the forward pointer 14a, the time information 14b, the index information 14c and the backward pointer 14d. On the other hand, in the fourth embodiment, each FAT entry tag in a FAT area 44 has only the forward pointer 14a. The others, the time information 14b, the index information 14c and the backward pointer 14d are not provided in each FAT entry tag. Instead, the time information 14b, the index information 14c and the backward pointer 14d are recorded in a time information area 41, an index area 42 and a backward pointer area 43 respectively which are provided in a recording medium. The time information area 41 includes time information corresponding to each FAT entry. The position of each time information on the time information area 41 corresponds to a position indicated by a forward pointer 14a of each FAT entry tag described in the FAT area 44. For example, in the case shown in FIG. 10, values of time information 14b of the FAT entry “1”, “2” and “3” are respectively recorded in areas (each of which is also called a pointer position) corresponding to value “1”, “2” and “3” each indicated by the forward pointer 14a on the time information area 41. In the same way, values of index information 14c of the FAT entries “1”, “2” and “3” are respectively recorded in areas corresponding to values “1”, “2” and “3” each indicated by the forward pointer 14a on the index area 42, and backward pointers 14d of the FAT entries “1”, “2” and “3” are respectively recorded in areas corresponding to values “1”, “2” and “3” each indicated by the forward pointer 14a on the backward pointer area 43.

When a FAT entry is referred to, the time information 14b, the index information 14c and the backward pointer 14d each located at corresponding pointer position in the time information area 41, the index area 42 and the backward pointer area 43 are referred to at the same time.

Also in the first and second embodiments, the time information area 41 and the index area 42 can be provided like the fourth embodiment.

### EXAMPLES

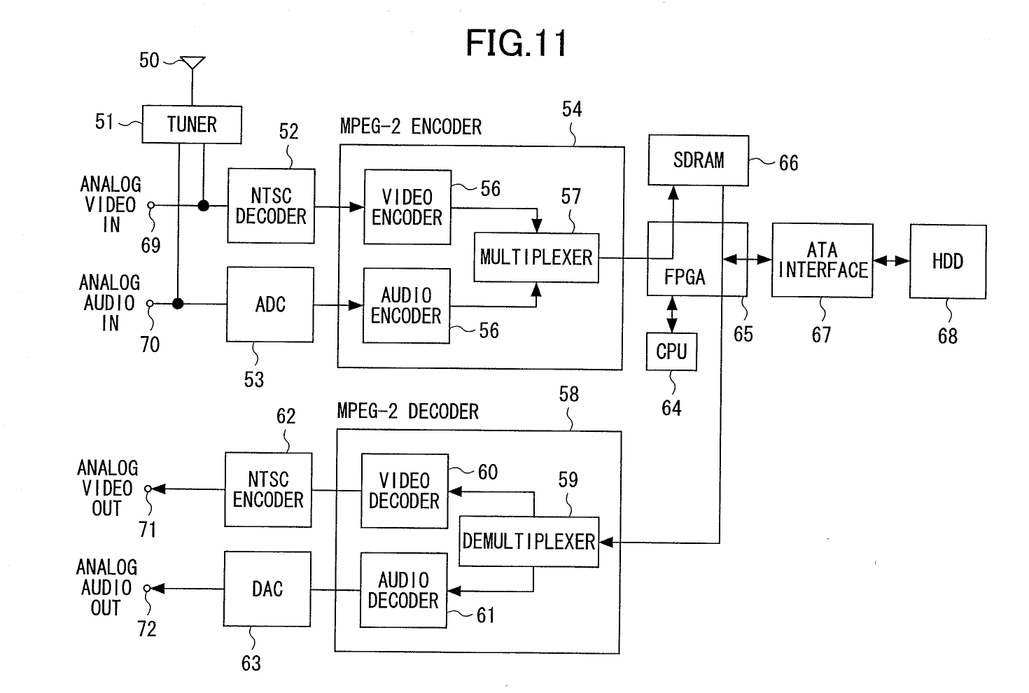

FIG. 11 shows a block diagram of a record and playback apparatus of an example of the present invention. The third embodiment is applied to this record and playback apparatus.

The record and playback apparatus includes a tuner 51 connected to an antenna 50, an NTSC decoder 52, an audio A/D converter (ADC) 53, an MPEG-2 encoder 54, an MPEG-2 decoder 58, an NTSC encoder 62, and an audio D/A converter (DAC) 63. The tuner 51, the NTSC decoder 52, the audio A/D converter (ADC) 53, and the MPEG-2 encoder 54 form an input system (a recording system) of the record and playback apparatus. The MPEG-2 decoder 58, the NTSC encoder 62, and the audio D/A converter (DAC) 63 form an output system (a playback system). An analog image signal from the outside or from the tuner 51 is provided to the NTSC decoder 52 via an input terminal 69, and an analog audio signal is provided to the audio A/D converter 53 via an input terminal 70. An analog image signal output by the NTSC encoder 62 is output to an external apparatus such as a TV via an output terminal 71. An analog audio signal output by the audio D/A converter 73 is output to an external apparatus via an output terminal 72.

The MPEG-2 encoder 54 includes an video encoder 55, an audio encoder 56 and a multiplexer 57. The MPEG-2 decoder 58 includes a demultiplexer 59, a video decoder 60 and an audio decoder 61.

In addition, the record and playback apparatus includes a CPU 64, an FPGA (Field Programmable Gate Array: which will be called a controller hereinafter) 65, SDRAM (Synchronous Dynamic Random Access Memory) 66, an ATA (ATA Interface: which will be called an interface part hereinafter) 67, and an HDD (Hard Disk Drive) 68. The video encoder 55 in the MPEG-2 encoder 54 performs coding and compression for an image signal which is decoded by the NTSC decoder 52 and outputs the compressed data to the multiplexer 57. In this coding and compression, compression method of MPEG2-Video is used for example. The audio encoder 56 performs coding and compression for a digital audio signal output from the audio A/D converter 53 and outputs the compressed data to the multiplexer 57. In this coding and compression, compression method of MPEG-1 Audio Layer2 is used for example. The multiplexer 57 multiplexes input image signal and audio signal and outputs a stream. MPEG-2 system PS format, for example, is used for this multiplexing.

The MPEG-2 encoder 54 of this configuration has a plurality of coding modes (which are also called as image quality modes or operation modes) used for defining bit rate for coding an image signal by a compression method such as MPEG. For example, the MPEG-2 encoder 54 has three modes which are a High Quality mode (HQ mode), a Standard Play mode (SP mode) and a Long Play mode (LP mode). A coding bit rate of the High Quality mode is 10 Mbps for example in which bit rate of image is 9.744 Mbps and bit rate of audio is 256 kbps. A bit rate of the Standard Play mode is 4 Mbps for example in which a bit rate of image is 3.744 Mbps and a bit rate of audio is 256 kbps. A bit rate of the Long Play mode is 2 Mbps for example in which a bit rate of image is 1.744 Mbps and a bit rate of audio is 256 kbps.

The demultiplexer 59 in the MPEG-2 decoder 58 separates an input signal into an image signal and an audio signal. The video decoder 60 decodes and expands an image signal which is coded by a compression method. The MPEG-2 decoder 58 has a plurality of decoding modes for defining bit rates when decoding and expanding the image signal corresponding to decoding modes of the MPEG-2 encoder 54. Like the MPEG-2 encoder 54, a High Quality mode, a Standard Play mode and a Long Play mode are included.

The controller 65 controls data transferring between the MPEG-2 encoder 54, the MPEG-2 decoder 58, the CPU 64, the SDRAM 66 and the interface part 67, and realizes control sequence of data transferring by programming many gate. In addition, the controller 65 includes a function for outputting control information corresponding to each part according to control information provided from a user by using a remote controller and the like. This point will be described later.

The SDRAM 66 stores a predetermined coded signal from the MPEG-2 encoder 54 and a coded signal read from the HDD 68 temporarily. The stored coded signal is read from the SDRAM 66 and output to the HDD 68 or to the MPEG 2 decoder 58. The interface part 67 forms an interface to the HDD 68 or other external recording apparatus.

The CPU 64 controls the whole image recording apparatus.

The tuner 51 is optional. Thus, if it is unnecessary, the record and playback apparatus can be configured without the tuner 51.

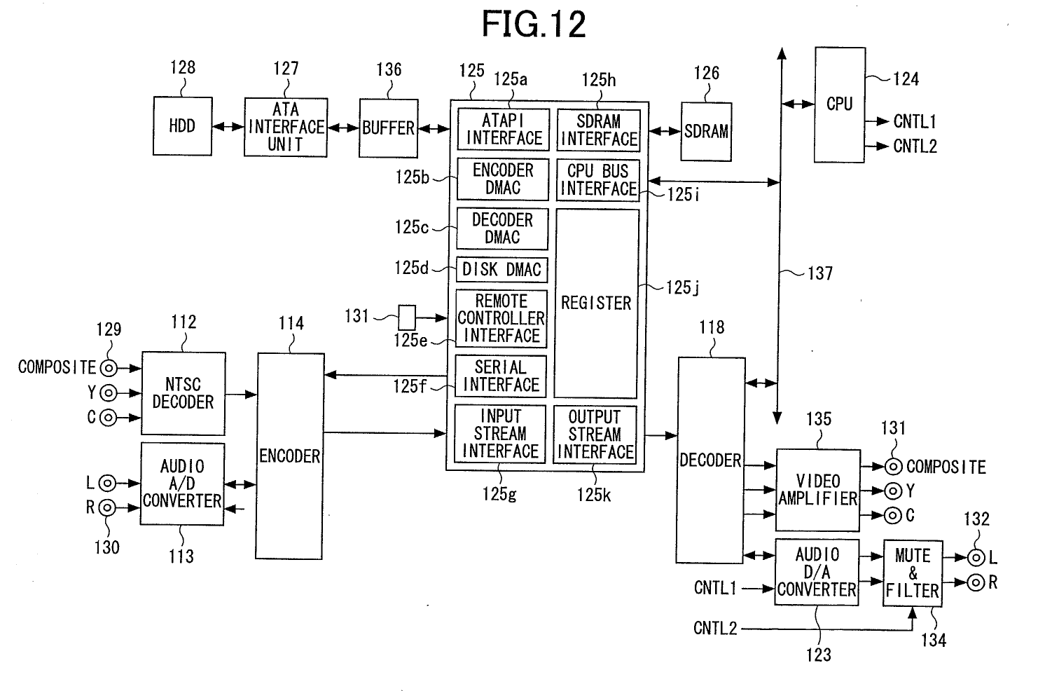

FIG. 12 is a block diagram showing the detailed configuration of FIG. 11.

The NTSC decoder 112 forms the NTSC decoder 52 in FIG. 11, and is SAA7113H of Philips for example. The NTSC decoder 112 converts a NTSC video signal into YC multiplexed 8 bit parallel signals, and outputs the signals. The audio A/D converter 113 forms the audio A/D converter 53 in FIG. 11, and is PCM1800 of Burr-Brown for example. The audio A/D converter 113 outputs a digital signal adhering to 12S. The MPEG-2 encoder 114 forms the MPEG-2 encoder 54 in FIG. 11, and, is MB86390A of Fujitsu for example. The MPEG-2 encoder 114 compresses an input image signal into an MPEG2MP@ML, and compresses an audio signal into MPEG-1 Layer2 (it can be said that a signal is coded by a predetermined compression method). These compressed image signal and audio signal are multiplexed by a multiplexer provided in the MPEG-2 encoder 114, and the multiplexed signal is output to the outside as a stream of MPEG-2 system PS format. The MPEG-2 decoder 118 forms the MPEG-2 decoder 58 of FIG. 11, and is MB86373B of Fujitsu for example. The MPEG-2 decoder 118 has the NTSC encoder 62 in the inside. An audio D/A converter 123 forms the audio D/A converter 63 in FIG. 11, and is PCM1723 of Burr-Brown for example, and converting the digital signal adhering to 12S to an analog signal and outputs the analog signal. A CPU 124 corresponds to the CPU 64 in FIG. 11, and is MB91107 of Fujitsu.

In addition, the record and playback apparatus shown in FIG. 12 includes a controller 125, an SDRAM 126, an ATA interface part 127, an HDD 128, input terminals 129, output terminals 130, a remote controller input part 131, a mute filter part 134, a video amplifier 135, a buffer 136, and a CPU bus 137. A TV monitor and the like is connected to the ATA interface part 127.

The controller 125 forms FPGA 65 shown in FIG. 11, and includes an ATA interface part 125a, an encoder DMAC (dynamic memory access controller) 125b, a decoder DMAC 125c, a DISC DMAC 125d, a remote controller interface 125e. a serial interface 125f, a stream input interface 125g, an SDRAM interface 125g, a CPU bus interface 125i, a register 125j and a stream output interface 125h.

The ATA interface part 125a forms an interface to the ATA interface part 127 via the buffer 136. The encoder DMAC 125b DMA-transfers a stream (in which an image signal and an audio signal are multiplexed) output by the encoder 114 to the SDRAM 126 via the stream input interface part 125g. Start and stop of this DMA-transferring are performed by setting predetermined codes in corresponding areas in the register 125j. The decoder DMAC 125c DMA-transfers a stream from the SDRAM 126 to the decoder 118 via the stream output interface 125h. Start and stop of this DMA-transferring are performed by setting predetermined codes in corresponding areas in the register 125j. The DISC DMAC 125d DMA-transfers data which is stored in an address in the HDD 128 corresponding to the HDD 68 in FIG. 11 to the SDRAM 126. Start and stop of this DMA-transferring are performed by setting predetermined codes in corresponding areas in the register 125j. The remote controller interface 125e receives various instructions from a remote controller, which is not shown in the figure, and sets predetermined codes in corresponding areas in the register 125j.

The serial interface 125f forms an interface for outputting a control signal such as mode setting signal to the encoder 114. The SDRAM interface 125h forms an interface to the SDRAM 126. The CPU bus interface 125i forms an interface to the CPU bus 137.

The CPU 124 controls each part via the CPU bus 137. For example, the CPU 124 checks a flag in the register 125i in the controller 125 and performs a corresponding processing. In addition, the CPU 124 outputs control signals CNTL1 and CNTL2 to the audio D/A converter 123 and the filter 134 so as to control an audio signal which is processed by these parts.

The input terminals 129 include a composite terminal, a Y terminal and a C terminal. The input terminals 130 include an L (left) terminal and an R (right) terminal. The output terminals 131 include a composite terminal, a Y terminal and a C terminal. The output terminal 132 includes an L (left) terminal and an R (right) terminal.

The DIR area 13 of the record and playback apparatus shown in FIG. 12 stores following file management information for each file:

| | |
|---|---|
| File name | 32 byte |
| Record start time (date) | 8 byte |
| Record end time (date) | 8 byte |
| Using cluster number | 4 byte (calculation of |
| | disk capacity) |
| System attribute 1 | 1 byte (prohibiting file |
| | deletion and the like) |
| System attribute 2 | 1 byte (file, directory and |
| | the like) |
| Pointer to leading FAT entry | 2 byte |
| Coding and compression method | 1 byte |
| System bit rate | 2 byte |
| Encoding mode | 1 byte (fixed/variable bit |
| | rate) |
| Encode video | 1 byte (NTSC/PAL) |
| Filter 134 parameter | 1 byte |
| System bit rate | 1 byte |
| D/A 123 sampling frequency | 2 byte |

(Operation of the Example)

Next, the operation of the record and playback apparatus shown in FIG. 12 will be described with reference to flowcharts. Following flowcharts show processes performed by the CPU 124 shown in FIG. 12. DMA processing (transferring operation between SDRAM of the FPGA and the hard disk) is performed by the controller 125. Basically, in the record and playback processing, initial file creation or open is processed by a main routine of the CPU 124, however, DMA processing or processing which requires high speed such as writing and reading of the hard disk is performed by interrupt processing routine.

FIG. 13 is a flowchart showing a main flow of recording operation. Initialization is performed in step S11. In this process, initialization of the NTSC decoder 112, initialization of the audio A/D converter 113, initialization of the controller 125, initialization of the DMA controllers (DMAC) 125b 125c and 125d and initialization of the encoder 114 are performed. Next, the encoder DMAC 125b is activated in step S12. More particularly, data is written into a corresponding activating register in a register 125 of the controller 125. Next, a new file is created in step S13, which will be described in detail later. After that, the encoder 114 is activated in step S14. In actual, recording to the HDD 128 is performed by an interrupt processing, which will be described later. In addition, the process shown in FIG. 13 is performed by the main routine in the CPU 124.

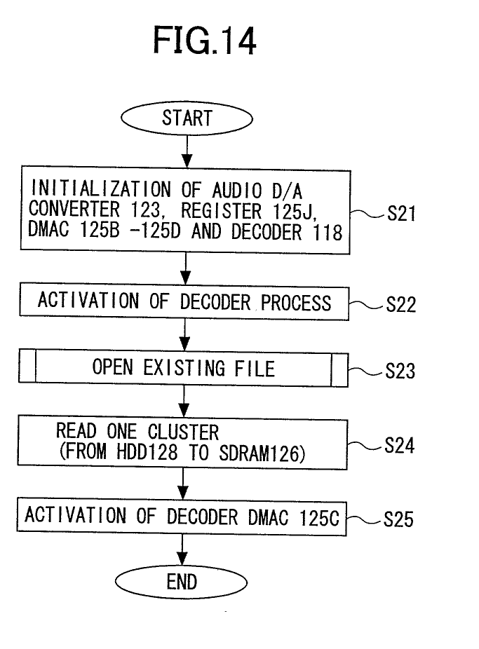

FIG. 14 is a flowchart showing a main flow for playback operation. Initialization is performed in step S21. In this process, initialization of the audio D/A converter 123, initialization of the register 125j, initialization of the DMAC 125b-125d and initialization of the decoder 118 are performed. The decoder is activate in step S22. An existing file specified on the HDD 128 is opened in step S23. In step S24, data of one cluster is DMA-transferred from the HDD 128 to the SDRAM 126 under control by the disk DMAC 125d. Next, in step S25, the decoder DMAC 125c is activated, and data is DMA-transferred from the SDRAM 126 to the decoder 118. The process of the step S25 can be performed cluster by cluster, or performed by some clusters together.

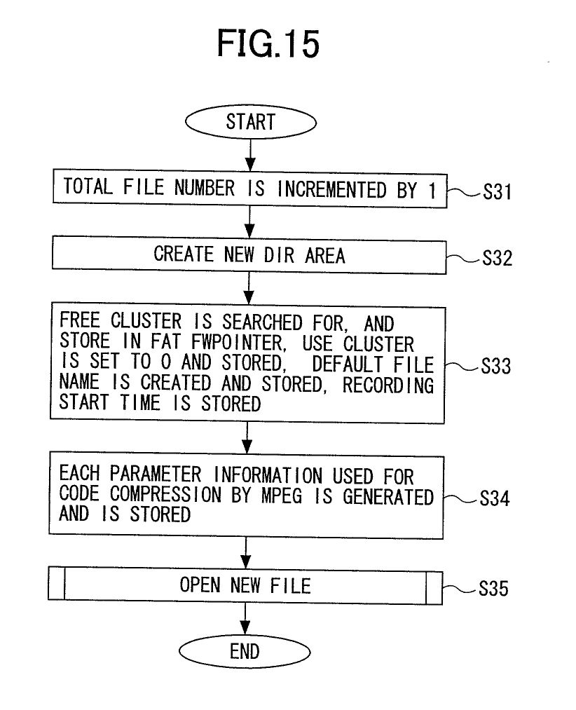

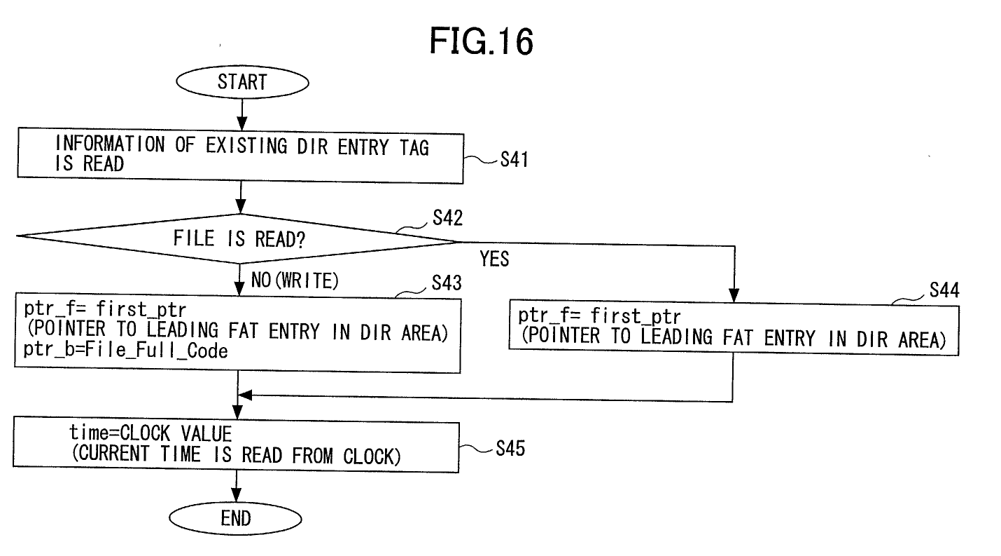

FIG. 15 is a flowchart showing a generation process of a new file. A basic file system management area is provided in the HDD 128 in addition to the before-mentioned DIR area 13 and FAT area (for example, FAT area 34 in FIG. 7). The total number of files is stored in the basic file system management area. In step S31, this information is incremented by 1. Next, in step S32, a new DIR area 13 is created (that is, a storing area corresponding to the new file is created in the DIR area 13. Then, in step S33, a next process is performed. A free cluster in the DISK area 15 on the HDD 128 is searched for. Then, a forward pointer value indicating a leading FAT entry of the DIR entry tag is assigned to the free cluster. In addition, use cluster is set to 0 and stored in the DIR entry tag. Further, default file name is created and stored in the DIR entry tag. In addition, recording start time is stored in the DIR entry tag. Further, necessary management information forming the DIR entry tag is stored in the DIR entry tag. Next, in step S34, before-mentioned parameter information used for code compression by MPEG is generated and is stored in the DIR entry tag of the DIR area 13. Then, in step S35, a new file is opened by performing an existing file open process, which will be described with reference to FIG. 16. As for the step S35, in order to provide commonality with a playback process, a new file is created when recording data, after that, an existing file open process is performed.

FIG. 16 shows the existing file open process. In step S41, DIR entry tag information recorded in the DIR area 13 is read. In step S42, different processes for variables in the program are performed according to whether the file is read or written. Each variable indicates following means.

ptr_f: variable of the forward pointer 14a

ptr_b: variable of the backward pointer 14d

ptr_c: variable of a current value pointer

time: variable of time

The variable of time indicates time of start of recording. Variables ptr_f, ptr_b, ptr_c are used for calculating a pointer of FAT on the basis of each operation.

When the judgment result in step S42 is NO (which means not reading), that is, when recording is performed, since data is written into HDD128, a pointer first_ptr to the leading FAT entry is substituted into ptr_f and a file end code (File_Full_Code) is substituted into ptr_b. On the other hand, when reading is performed, first_ptr is substituted into ptr_c in step S44. In step S45 next to steps S43 and S44, a current time is read out from a clock (which is provided in the encoder 114 for example) and is set in the variable time.

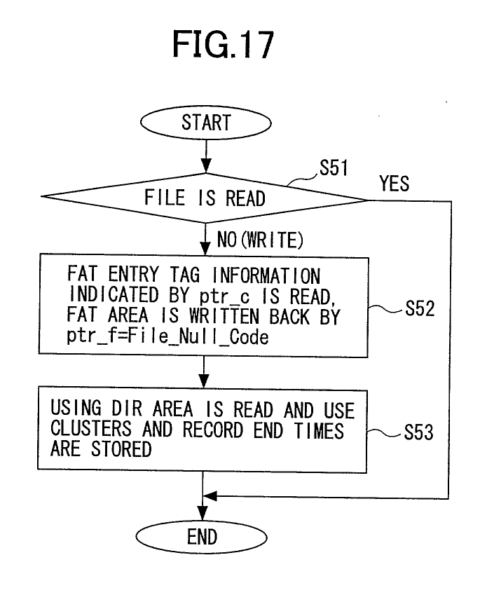

FIG. 17 is a flowchart showing an existing file close process. In step S51, it is judged whether the file is read or not. When the file is written, FAT entry tag information indicated by the variable ptr_c is read in step S52, a file termination code is set in ptr_f, and these variables are written back to the FAT area 34. In addition, the using DIR area 13 is read and use clusters and record end times are stored.

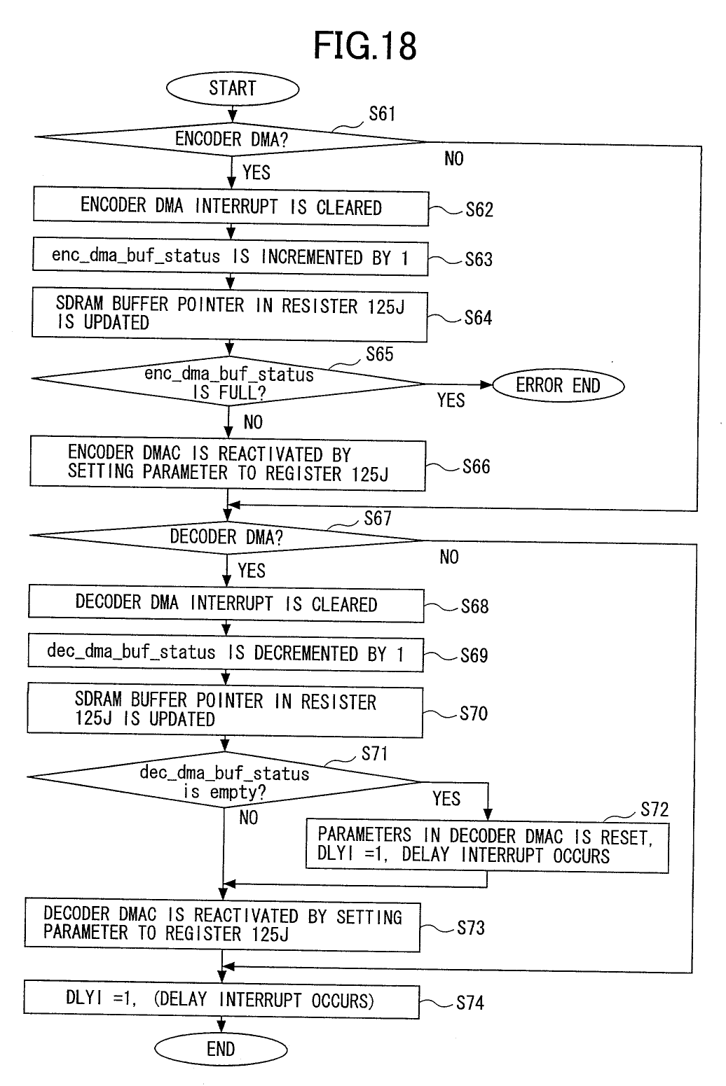

FIG. 18 is a flowchart showing a DMA process. As for interruption, the encoder DMAC 125b and the decoder 125c exist for one interrupt signal (which is not shown in FIG. 12 for the same of simplicity) output from the controller 125.

In addition, the DISK DMAC 125d exists, that is, a delay interrupt of software interrupt activation which is issued from the interrupt DMA process exists. Write to or read from the HDD 128 is activated by this delay interrupt (DISK DMAC 125d).

When a request for DMA transfer of the encoder DMAC 125b occurs in step S61, the interrupt is cleared in step S62, and a variable enc_dma_buf_status is incremented by 1. The variable enc_dma buf_status indicates the number of buffers of the SDRAM 126. This variable is incremented by interrupt of the encoder side, which indicates that data is stored. This is normally set as 64 kbytes.

The SDRAM buffer pointer is managed by software processed by the CPU 124. In step 64, the SDRAM buffer pointer in the resister 125j is updated. When the value of the variable enc_dma_buf_status is judged to be full, it means that the buffer 125j overflows so that an error occurs (error end). When the buffer does not overflow, the encoder DMAC 125b is reactivated in step S66.

In step S67, it is judged whether a DMA transfer request of the decoder DMAC 125c occurs. When the request for DMA transfer by the decoder DMAC 125c occurs, the interrupt is cleared in step S68, and a variable dec_dma_buf_status is decremented by −1. The variable dec_dma_buf_status indicates the number of buffers of the SDRAM. The variable is decremented by interrupt in the decoder side, which indicates that data is consumed. This is normally set to be 64 k bytes.

The SDRAM buffer pointer is managed by software by processing of the CPU 124. The SDRAM buffer pointer in the register 125j is updated in step S70. When it is judged that the variable dec_dma_buf_status is empty in step S71, it means that reading data from the HDD 128 to the buffer 136 is delayed so that data is not provided to the decoder 118. A mechanism is realized in which it is not regarded as an error and the process can be continued since there is a case that the decoder 118 requests data excessively in this case.

When dec_dma_buf_status is empty in step S71, parameters in the decoder DMAC125c is reset, and a variable DLYI is set to be 1 so that a delay interrupt occurs in step S72. Accordingly, data transfer from the HDD 128 to the SDRAM 126 by the DISK DMAC 125d is instructed.

After that, parameters are reset to the register 125j in step S73, and the decoder DMAC 125c is reactivated. Then, DLYI is set to be 1 in step S74 and a delay interrupt for DMA transfer by using the DISK DMAC 125d is issued. The delay interrupt is an interrupt which can be set by software. At the time when this DMA process ends, if there is not a higher priority interrupt, the process is performed.

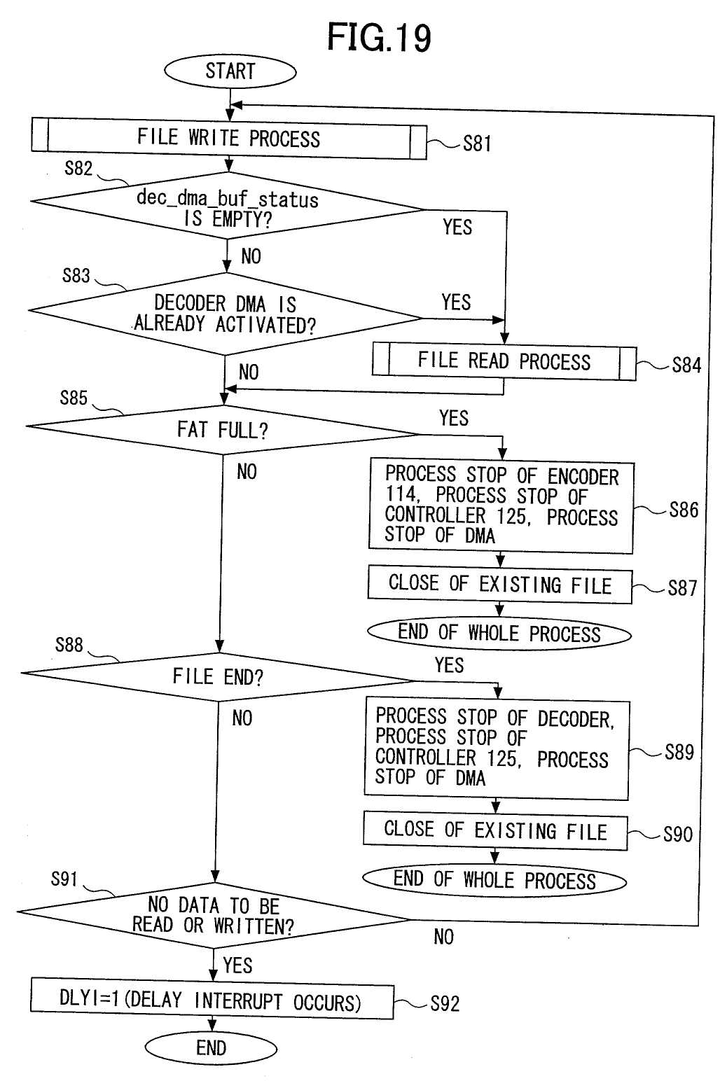

FIG. 19 is a flowchart showing a file access process (file access process by the DISK DMAC 15d) performed by the delay interrupt. A file write process is performed in step S81.

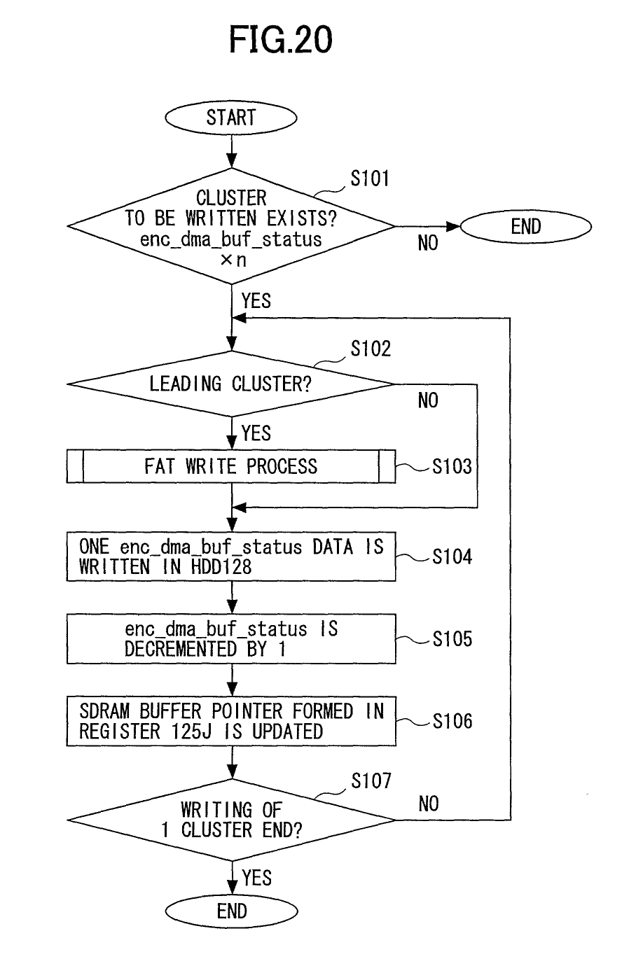

FIG. 20 is a flowchart showing the file write process. It is judged whether a cluster to be written exists in step S101. When clusters corresponding to the amount of data do not exist, the process ends. An integral multiple of the variable enc_dma_buf_status are set as the size of the cluster. For example, 1 cluster is set to be 1 M bytes which is 16 times of the variable. Next, a leading cluster is judged in step S102. When the leading cluster is found, a FAT write process is performed in step S103. The FAT write process is for writing data to the FAT area 34. Next, 64 kbytes which corresponds to one enc_dma_buf_status is written in step S104. For both of the FAT write process and 64 kbytes writing, the DISK DMAC 125d of the controller 125 is used. More particularly, data is written into an activation register of the DISK DMAC 125d which is provided in the register 125j. Issuing of an ATA command to the HDD 128 is performed by the CPU 124 before the process of the DISK DMAC 125d is performed (also in this process, written in the register 125j of the controller 125).

Next, the variable enc_dma_buf status is decremented by 1 in step S105. This corresponds to the process that the variable enc_dma_buf_status is incremented by 1 in step S63 shown in FIG. 18. (a buffer management is performed in which the variable is incremented in the encode process and decremented in writing to the HDD 128) Since the SDRAM buffer pointer is managed by software by the processing of the CPU 124, the SDRAM buffer pointer formed in the register 125j in the controller 125 is updated in step S106. Then, steps from S102 to S106 are repeated until a judgment result of step S107 becomes YES.

In step S82 of FIG. 19, it is judged whether dec_dma_buf_status is empty. When it is empty, a file read process is performed in step S84. When dec_dma_buf_status is not empty in step S82, it is judged whether the decoder DMAC 125c has been activated in step S83. When it has been activated, step S84 is performed.

In step S85, it is judged whether the FAT area 34 becomes full. The size of the FAT area can be calculated as explained in the first embodiment. When it is judged that the FAT area is full in step S85, it means that the HDD 128 is full. Thus, an end process (processes of the encoder 114, the controller 125, and DMA are stopped) is performed in step S86, and the existing file is closed in step S87.

It is judged whether the file ends in step S88. When it is judged that the file ends, an end process (processes of the decoder 118, the controller 125, and DMA are stopped) is performed in step S89, and the existing file is closed in step S90. When the judgment result of step S88 is NO, it is judged whether data for file write or file read exists in step S91. When there is such data, DLYI is set to 0 in step S92 so that the delay interrupt ends.

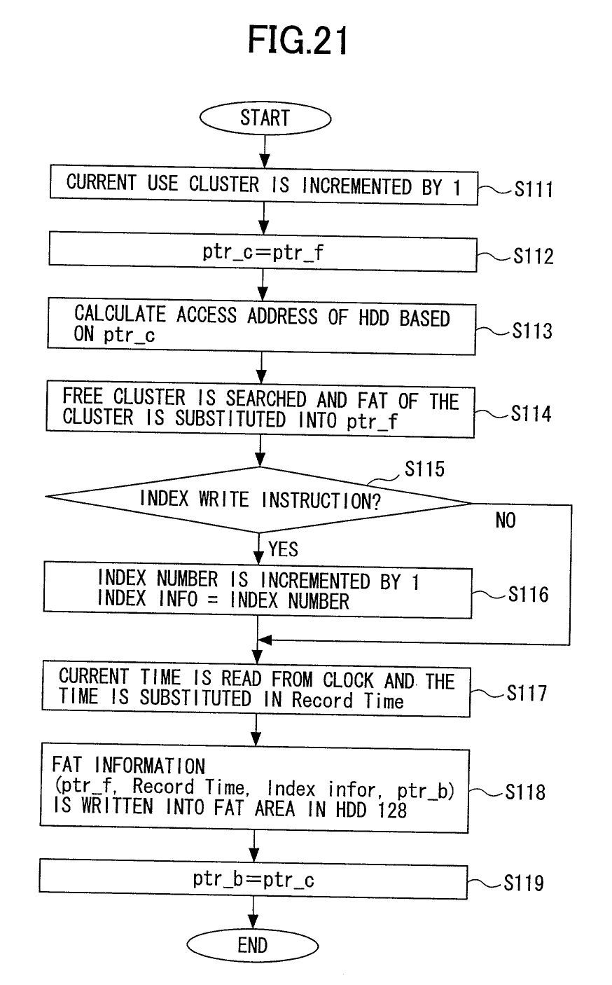

FIG. 21 shows a flowchart showing a write process to the FAT area 34.

A write process is performed on a FAT of a leading cluster, and a current using cluster is incremented by 1 in step S111. After that, the forward pointer ptr_f is substituted into a current value pointer ptr_c in step S112. In step S113, an address in the HDD 128 is calculated on the basis of the current value pointer ptr_c. In step S114, a free cluster is searched for and the FAT of the cluster is substituted into the forward pointer ptr_f. When it is judged that there is an instruction to write index information in step S115, an index number is incremented by 1 in step S116, and the index number is stored into index information Index Info (which corresponds to the before-mentioned index information 14c). In addition, a current time is read from a clock and the time is stored in the time information Record Time (which corresponds to the before-mentioned time information 14b).

A series of FAT entry tag information, that is, the forward pointer ptr_f, the time information Record Time, the index information Index Info, and the backward pointer ptr_b are written into the FAT area 34 of the HDD 128. Then, the current value pointer ptr_c is substituted into the backward pointer ptr_b in step S119.

By using the pointers ptr_f and ptr_b shown in FIG. 21, a forward and backward pointer chain of the FAT area 34 can be realized.

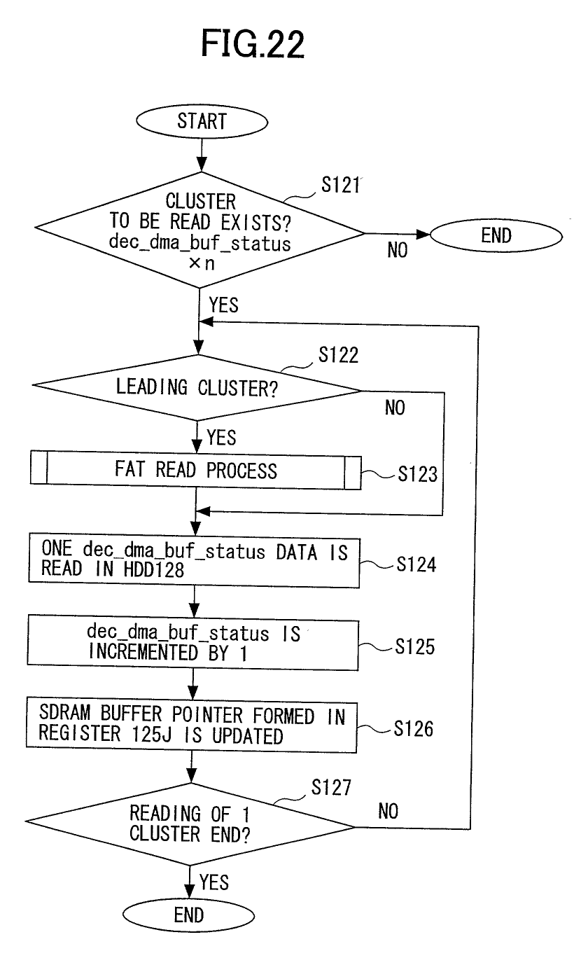

FIG. 22 shows a flowchart indicating a file read process. This is basically the same as the file write process shown in FIG. 20. It is judged whether a cluster to read exists in step S121. When the cluster do not exist, the process ends. An integral multiple of the variable dec_dma_buf status are set as the size of the cluster. For example, 1 cluster is set to be 1 M bytes which is 16 times of the variable. Next, a leading cluster is judged in step S122. When the leading cluster is found, a FAT read process is performed in step S123. The FAT read process is for reading data from the FAT area 34. Next, 64 kbytes which corresponds to one dec_dma_buf status is read in step S124. For both of the FAT read process and 64 kbytes reading, the DISK DMAC 125d of the controller 125 is used. More particularly, data is written into an activation register of the DISK DMAC 125d which is provided in the register 125j. Issuing of an ATA command to the HDD 128 is performed by the CPU 124 before the process by the DISK DMAC 125d is performed (also in this process, written in the register 125j of the controller 125).

Next, the variable dec_dma_buf_status is incremented by 1 in step S125. This corresponds to the process that the variable dec_dma_buf_status is decremented by 1 in step S69 shown in FIG. 18. (a buffer management is performed in which the variable is decremented in the decode process and incremented when reading from the HDD 128) Since the SDRAM buffer pointer is managed by software by the processing of the CPU 124, the SDRAM buffer pointer formed in the register 125j in the controller 125 is updated in step S126. Then, steps from S122 to S126 are repeated until a judgment result of step S127 becomes YES, that is, reading of 1 cluster ends.

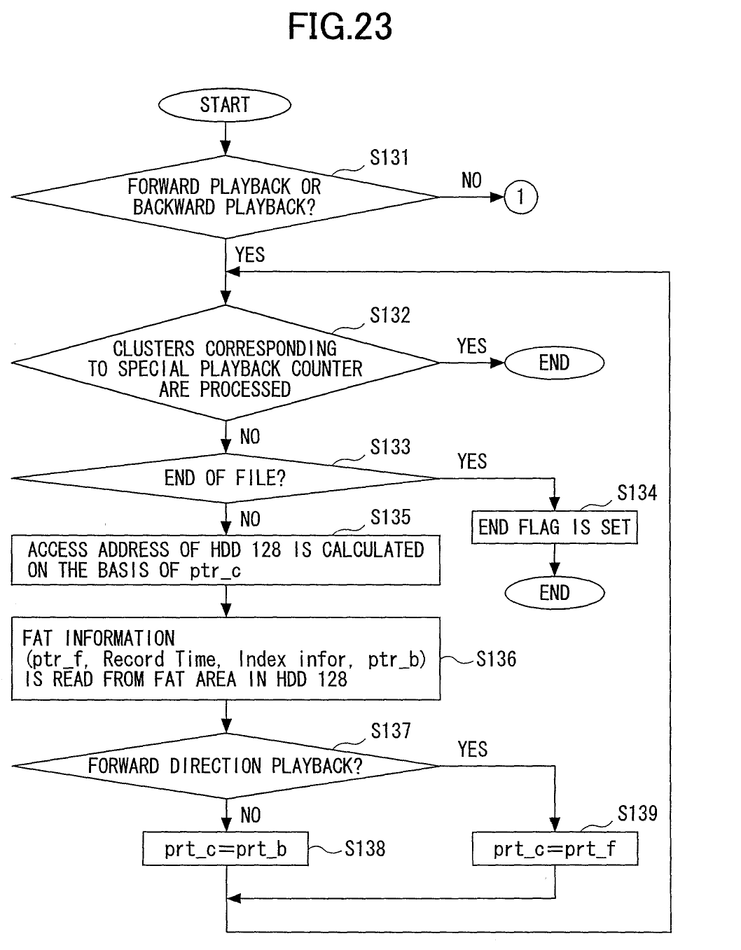

FIG. 23 is a flowchart indicating a FAT read process.

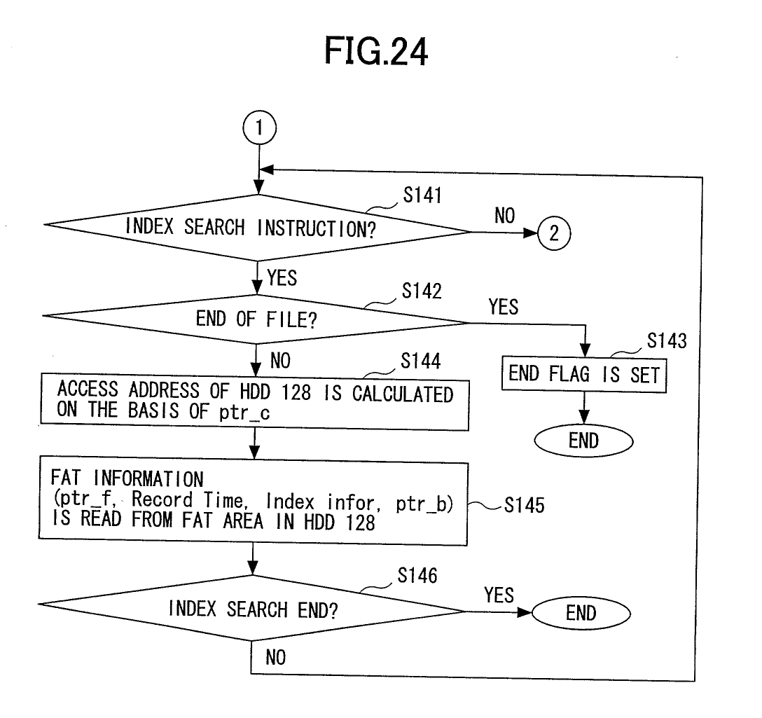

In step S131, it is judged whether forward playback or backward playback is indicated. When forward playback or backward playback is instructed, further processes are performed. When it is not instructed, the process moves to a judgment process of index search instruction indicated by \mathring{1} (FIG. 24).

When forward playback or backward playback is instructed, it is judged whether clusters corresponding to special playback counter are processed. The special playback counter is for counting a count value corresponding to a data amount which should be played back. Next, whether the file ends or not is checked in step S133. When the file ends, an end flag is set in step 134. When the file does not end, an address in the HDD 128 is calculated on the basis of the current value pointer ptr_c in step S135, and a series of information (ptr_f, Record Time, Index Info, ptr_b) of the FAT entry tag is read from the HDD 128.

It is judged whether the playback is forward or backward in step 137, a variable which is substituted into the current value pointer ptr_c is changed according to whether the playback is forward or backward. The current value pointer ptr_c is used for instructing next cluster reading. When the playback is forward, the current value pointer ptr_c is substituted into the forward pointer ptr_f. When the playback is backward, the current value pointer ptr_c is substituted into the backward pointer ptr_b. Then, the process returns to step S132.

When the judgment result of step S131 is NO and the process moves to FIG. 24, it is judged whether there is an index search instruction in step S141. When the index search is not instructed, the process moves to judgment process for time search instruction.

When there is an index search instruction, it is judged whether the file ends in step S142. When the file does not end, an address of the HDD 128 is calculated on the basis of the current value pointer ptr_c. Then, series of Fat entry tag information (ptr_f, Record Time, Index Info, ptr_b) is read from the HDD 128. Then, steps from S141 to S146 are repeated until the judgement result of step S146 becomes YES, that is, until a number instructed in the index information Index Info is recognized. When the index search instruction disappears in the process, normal playback is performed from that point.

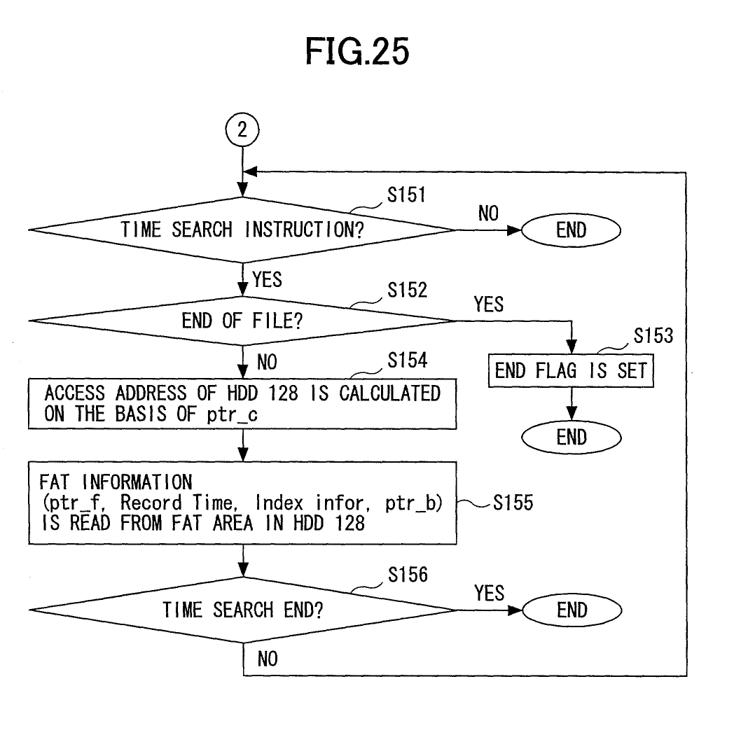

In the process shown in FIG. 25, when it is judged that there is the time search instruction in step S151, the process goes to step S152. When there is not the time search instruction, the FAT read process started from FIG. 23 ends. When there is the time search instruction in step S151, it is checked whether the file ends in step S153. When it is judged that the file ends, an end flag is set in step S153. When the file does not end yet, an address of the HDD 128 is calculated on the basis of the current value pointer in step S154 and a series of FAT entry tag information (ptr_f, Record Time, Index Info, ptr_b) is read from the HDD128. Steps from S151 to S156 are repeated until the time information Record Time agrees with instructed time, that is, until the judgment result of step S156 becomes YES. When the time search instruction disappears at some midpoint, normal playback process starts from that point.

As mentioned above, the record and playback apparatus shown in FIGS. 11 and 12 is an example in which the third embodiment of the present invention is applied. Therefore, various record and playback processes can be realized by using the time information Record Time, the index information Index Info and the backward pointer ptr_b.

The CPU 124 shown in FIG. 12 functions as the following control part. By comparing a specified time specified from the outside with the time information, the CPU 124 functions as a control part for causing the record and playback apparatus to start playback operation from a recording unit corresponding to the specified time. In addition, by comparing a specified time interval specified from the outside with the time information, the CPU 124 functions as a control part for causing the record and playback apparatus to perform playback operation including recording units corresponding to the specified time interval. In addition, by comparing specified index information specified from the outside with the index information which is stored, the CPU 124 functions as a control part for causing the record and play back apparatus to perform playback operation including a recording unit corresponding to the specified index information. Further, by comparing a specified backward pointer which is specified from the outside with the stored backward pointer, the CPU 124 functions as a control part for causing the record and playback apparatus to perform playback operation from a recording unit specified by the specified backward pointer.

Since the third embodiment is applied to the above-mentioned example, the above-mentioned example includes the first embodiment or the second embodiment. However, the first embodiment or the second embodiment can be applied to the configuration shown in FIGS. 12 and 13. In addition, file management can be performed by providing only the backward pointer 14d or the index information 14c.

In the above-mentioned example, although the HDD 128 is used as the recording medium, the recording medium is not limited to the HDD 128. Other recording medium such as DVD can be used.

As mentioned above, according to the present invention, a record and playback apparatus having ease-of-use features can be provided.

The present invention is not limited to the specifically disclosed embodiments, and variations and modifications may be made without departing from the scope of the invention.

What is claimed is:

1. A record and playback apparatus which codes information and records said information which is coded in a recording medium, wherein:
said record and playback apparatus stores, in a predetermined management area provided in said recording medium, management information including at least one of time information on a time when said information is coded, index information which can be assigned to a recording unit, and a backward pointer for connecting recording units in a backward direction.

2. The record and playback apparatus as claimed in claim 1, wherein said predetermined management area is a FAT area, and said management information is provided in said FAT area.

3. The record and playback apparatus as claimed in claim 1, wherein said predetermined management area storing said management information is an area provided separately from said FAT area.

4. The record and playback apparatus as claimed in claim 1, wherein said predetermined management area storing said management information is an area provided separately from said FAT area, and said predetermined management area is provided for each of said time information, said index information and said backward pointer.

5. The record and playback apparatus as claimed in claim 1, wherein said predetermined management area is a FAT area, and said management information is information which forms a FAT entry tag provided in said FAT area.

6. The record and playback apparatus as claimed in claim 1, wherein:
said management information includes said time information; and
said record and playback apparatus comprises a control part which causes said record and playback apparatus to perform playback operation from a recording unit corresponding to a time specified from the outside by comparing said time with said time information.

7. The record and playback apparatus as claimed in claim 1, wherein:
said management information includes said time information; and
said record and playback apparatus includes a control part which causes said record and playback apparatus to perform playback operation including recording units corresponding to a time interval specified from the outside by comparing said time interval with said time information.

8. The record and playback apparatus as claimed in claim 1, wherein:
said management information includes said index information; and
said record and playback apparatus includes a control part which causes said record and playback apparatus to perform playback operation including a recording unit corresponding to a specified index information specified from the outside by comparing said specified index information with said index information.

9. The record and playback apparatus as claimed in claim 1, wherein:
said management information includes said backward pointer; and
said record and playback apparatus includes a control part which causes said record and playback apparatus to perform playback operation from a recording unit indicated by a specified backward pointer specified from the outside by comparing said specified backward pointer with said backward pointer.

10. A record and playback method for coding information and recording said information which is coded in a recording medium in a record and playback apparatus, said record and playback method comprising the step of:
performing playback operation according to management information stored in a predetermined management area provided in said recording medium, said management information including at least one of time information on a time when said information is coded, index information which can be assigned to a recording unit, and a backward pointer for connecting recording units in a backward direction.

11. The record and playback method as claimed in claim 10, wherein said predetermined management area is a FAT area, and said management information is provided in said FAT area.

12. The record and playback method as claimed in claim 10, wherein said predetermined management area storing said management information is an area provided separately from said FAT area.

13. The record and playback method as claimed in claim 10, wherein said predetermined management area storing said management information is an area provided separately from said FAT area, and said predetermined management area is provided for each of said time information, said index information and said backward pointer.

14. The record and playback method as claimed in claim 10, wherein said predetermined management area is a FAT area, and said management information is information which forms a FAT entry tag provided in said FAT area.

15. The record and playback method as claimed in claim 10, wherein said management information includes said time information, said record and playback method comprising the step of:
controlling said record and playback apparatus to perform playback operation from a recording unit corresponding to a time specified from the outside by comparing said time with said time information.

16. The record and playback method as claimed in claim 10, wherein said management information includes said time information; said record and playback method comprising the step of:
controlling said record and playback apparatus to perform to perform playback operation including recording units corresponding to a time interval specified from the outside by comparing said time interval with said time information.

17. The record and playback method as claimed in claim 10, wherein said management information includes said index information, said record and playback method comprising the step of:
controlling said record and playback apparatus to perform playback operation including a recording unit corresponding to a specified index information specified from the outside by comparing said specified index information with said index information.

18. The record and playback method as claimed in claim 10, wherein said management information includes said backward pointer, said record and playback method comprising the step of:
controlling said record and playback apparatus to perform playback operation from a recording unit indicated by a specified backward pointer specified from the outside by comparing said specified backward pointer with said backward pointer.
